SEQUENCE LISTING (2 sequences)

SEQ ID NO: 1 - DNA, 14 bp, Artificial Sequence
  Primer sequence
agcatggcgccttt

SEQ ID NO: 2 - DNA, 12 bp, Artificial Sequence
  Primer sequence
aggcgccatgct

(19) United States
(12) Patent Application Publication
(10) Pub. No.: US 2007/0036026 A1
(43) Pub. Date: Feb. 15, 2007

(54) Magnetic Particle Systems and Methods

(76) Inventors: Paul Edward Laibinis, Brentwood, TN (US); Sandip Agarwal, Houston, TX (US)

Correspondence Address: BAKER BOTTS, LLP, 910 LOUISIANA, HOUSTON, TX, 77002-4995, US

(21) Appl. No.: 11/383,704

(22) Filed: May 16, 2006

Related U.S. Application Data
(60) Provisional application No. 60/681,264, filed on May 16, 2005.

(51) Int. Cl. B01F 13/08

(52) U.S. Cl. 366/273; 366/DIG. 4

(57) ABSTRACT

Systems comprising a fluid chamber comprising a fluid disposed within the fluid chamber, wherein the fluid comprises a plurality of magnetic particles disposed within the fluid and a magnetic field source disposed operative with the fluid chamber to provide a magnetic field to the fluid chamber. Methods for mixing comprising providing a plurality of magnetic particles disposed within a fluid and applying a magnetic field to the magnetic particles such that the magnetic particles move within the fluid. Articles comprising a fluid chamber that comprises a fluid disposed within the fluid chamber, wherein the fluid comprises a plurality of magnetic particles disposed within the fluid.

### CROSS-REFERENCE TO RELATED APPLICATION

This Application claims the benefit under 35 U.S.C § 119 of U.S. Provisional Application No. 60/681,264, filed May 16, 2005.

### STATEMENT OF GOVERNMENT INTEREST

This disclosure was developed at least in part using funding from the National Science Foundation, Award Number EEC-0118007. The U.S. government may have certain rights in the invention.

### BACKGROUND

Microfluidic and microarray technologies have considerable applications in bioanalytical diagnostics, drug screening, and microreactors, primarily because of low sample requirements, high-throughput analysis, and portability. These devices often have at least one dimension that may be in the range of 100 microns. The promise of microfluidic technology lies in their inexpensive fabrication, operational simplicity, and fast response time.

Mixing of solutions within microanalytical devices with thin film geometries (thickness of <1 μm to 1 mm) is difficult. These thin film geometries are frequently encountered in microarrays, microfluidic devices, and lab-on-a-chip applications. Since the fluids within microfluidic chambers are either stagnant (for example in microarrays), or have low Reynolds Number (essentially in the creeping regime with Re<1), the mixing of fluids within such chambers is entirely diffusion-dependent, and therefore slow. This may be compounded for macromolecules (DNA, proteins, polymers, etc.) that have diffusivities two-orders of magnitude lower than commonly used liquids. In larger systems (with dimensions of a few mm and above), turbulence is often a means to achieve mixing, but the thin geometries in microfluidic chambers imply low Reynolds numbers, and consequently no turbulence. Thus, to mix fluids in such geometries, it is often necessary to manipulate the fluid to increase the interfacial contact area between two fluid streams.

Microanalytical devices have many potential applications, including, but not limited to, uses in the life sciences, defense, chemical reactions, public health, and agriculture. These devices often have thin film geometries, and therefore they require only a small amount of sample and reagent for each assay. Such geometries can be encountered in high-throughput devices called microarrays, in which large numbers (hundreds to tens of thousands) of biomolecules such as nucleic acids, proteins, carbohydrates, or drug molecules can be analyzed in parallel. In a typical microarray, about 25-100 μL of solution is spread over 10 cm of microarray surface, to give a device thickness of about 25-100 μm. The solution phase species, or the targets, bind or “hybridize” to the surface spotted probes based on their complimentarity. The solution within such chambers may be stagnant; therefore the movement of solution phase species to surface probe sites may be dependent on pure diffusion, which is generally slow, among other things, because of large size of the biomolecules. For example in a DNA microarray, the time taken for a 250 base single stranded DNA molecule with diffusion constant of D≅2.5×10⁻¹¹ m² s⁻¹ to traverse 1 cm can be estimated to be τ_{d}=L²/D≅1000 hours. In current practice, a DNA hybridization assay is performed for around 16-24 hours. Apart from the issue of large assay times, target depletion can occur near probe spots, especially for low-abundance target molecules, leading to poor signals. Also, lack of mixing leads to overlapping diffusional profiles, in which duplicate probe molecules spotted adjacent to each other react with solution phase species from overlapping regions, thus leading to weak and inconsistent signals from those spots.

Mixing the solution within microanalytical chambers would lead to more homogenous concentrations, and possibly faster kinetics, shorter assay times, and better sensitivities. Conventional mixing strategies such as magnetic or mechanical stirring are difficult to employ in these devices because of their thin film geometries. Various alternative approaches have been suggested to enhance the mixing process in microanalytical devices, for example moving an air bubble within the microfluidic device, fabricating magnetic microstirrers on the chamber surface, or pumping the solution back and forth. Though these devices have showed reduced reaction times and increased sensitivity, they suffer from drawbacks such as increased sample volume, larger chambers, or complicated fabrication strategies of the chamber. It is desirable to mix the stagnant solution within these geometries, without any complicated fabrication strategy or without increasing the sample volume.

### SUMMARY

The systems, methods, and articles of the present disclosure may allow for, among other things, improved signal quality and reduced sample volumes, as well as the ability to overcome diffusional limitations. The systems, methods, and articles of the present disclosure may be used with microfluidic and microarray technologies and have considerable applications in bioanalytical diagnostics, drug screening, and microreactors. Further, the systems, methods, and articles of the present disclosure have wide application in areas including, but not limited to, uses in the life sciences, defense, chemical reactions, public health, and agriculture.

The present disclosure provides, according to certain embodiments, systems, methods, and articles that comprise magnetic particles and magnetic fields. Magnetic particles may be introduced into fluid chambers, and the magnetic fields manipulated to move or mix the particles. Under application of a remote magnetic field magnetic particles form solid-like structures, and when an external magnetic field is translated, the solid-like structure inside the chamber moves along with the field. By patterning the magnetic field, different patterns of flow could be achieved inside the chamber. Thus, magnetic particles may be used to enhance mixing within such chambers.

The features and advantages of the present disclosure will be readily apparent to those skilled in the art upon a reading of the description of the embodiments that follows.

### FIGURES

Some specific example embodiments of this disclosure may be understood by referring, in part, to the following description and the accompanying drawings.

FIG. 1 is a schematic showing an experimental set up for visualization of mixing. A neodymium block magnet with one or multiple notches along its top edge is translated in two directions under computer control with a X-Y translation stage. The chamber is placed above the magnet, and the mixing is visualized using a CCD camera. An electroluminescent sheet placed between the magnet and the chamber serves as a light source for imaging.

FIG. 2 is an illustration of an example of a polymer-coated magnetite magnetic particle with size range of around 8 nm.

FIG. 3 are images recorded at various time intervals during mixing with a magnet having one notch at the center of the magnet. (a) The initial state. After (b) 1.5 min, (c) 3 min, (d) 4.5 min, and (e) 6 min of mixing. The dotted white lines in (a) shows the axis of translation of the magnet. The chamber has dimensions of 20 mm×50 mm and a height of 120 μm. Initially the dye is at the center, and magnetic fluid at the right end. The magnet moves linearly at a speed of 0.25 mm/s, taking 3 min to travel 45 mm.

FIG. 4 are images recorded at various time intervals during mixing with a magnet having three notches in the magnet. (a) The initial state. After (b) 1.5 min, (c) 3 min, (d) 4.5 min, and (e) 6 min of mixing. The dotted white lines in (a) shows the axis of translation of the magnet.

FIG. 5 are images recorded at various time intervals during mixing with a magnet having three notches and translated in a saw tooth pattern. Mixing of the dye for saw tooth motion of a magnet with three notches. (a) The initial state. After (b) 1.5 min, (c) 3 min, (d) 4.5 min, and (e) 6 min of mixing. The dotted white lines in (a) shows the saw tooth motion of axis of the magnet. Note the streaks of dye from the center of the chamber towards the sidewalls in (c) which were not present for the linear motion of the magnet.

FIG. 6 are images recorded after the first 15 min for various mixing modes. (a) No mixing is observed if the mixing is dependent on diffusion alone; (b) Mixing for the case when there is one notch in the magnet; (c) Mixing when there are three notches in the magnet; (d) Mixing for the case of three notches, two dimensional saw tooth motion of the magnet; (e) The ratio of standard deviation and mean of concentration for various mixing patterns plotted against time for the first 30 min; (♦) for no mixing; (□) for 1 notch, linear motion of the magnet, speed=0.1 mm/s; (▴) for 1 notch linear motion; speed=0.25 mm/s; (▪) for 3 notch linear motion, speed=0.25 mm/s (Δ) for 3 notch, saw tooth motion, speed=0.25 mm/s. The lines joining the points are intended to serve as a guide to the eye.

FIG. 7 are schematics of the mixing chamber. (a) A standard glass slide is spotted with an erioglaucine dye. (b) A PDMS chamber of dimension 50 mm×20 mm×140 μm is formed. (c) The chamber is filled with water, and magnetic particles introduced at one of the ends (d) An Nd magnet is used to move the particles. It has three notches as shown. (e) The chamber is placed on top of the magnet.

FIG. 8 are TEM images of different magnetic particles. (a-c) Monodisperse magnetic particles with diameters of (a) 9 nm (b) 12 nm and (c) 16 nm. (e) Polydisperse particles with a mean diameter of 9.5 nm.

FIG. 9 are images of mixing of a dye during the first 24 min for (A) 9 nm and (B) 16 nm particles. The magnet is moving at a velocity of 0.25 mm/s in each direction. The dotted white line in the first Figure indicates the direction of motion. The 9 nm particles provide better mixing as compared to 16 nm particles.

FIG. 10 is a graph showing quantification of mixing for 9 nm (e) and 16 nm (▴) particles with time. The mixing parameter, γ, is the ratio of standard deviation over mean of concentration of the dye. The velocity of the magnet is 0.25 mm/s in each direction.

FIG. 11 are images of mixing for 12 nm particles (A) after one pass and (B) after 15 min. For each case, images are shown for four different velocities of of 0.05 mm/s, 0.10 mm/s, 0.25 mm/s, and 0.75 mm/s.

FIG. 12 is a graph showing the value of k at different velocities of the magnet with particles of diameter of 9 nm (●), 12 nm (□), and 16 nm (▴).

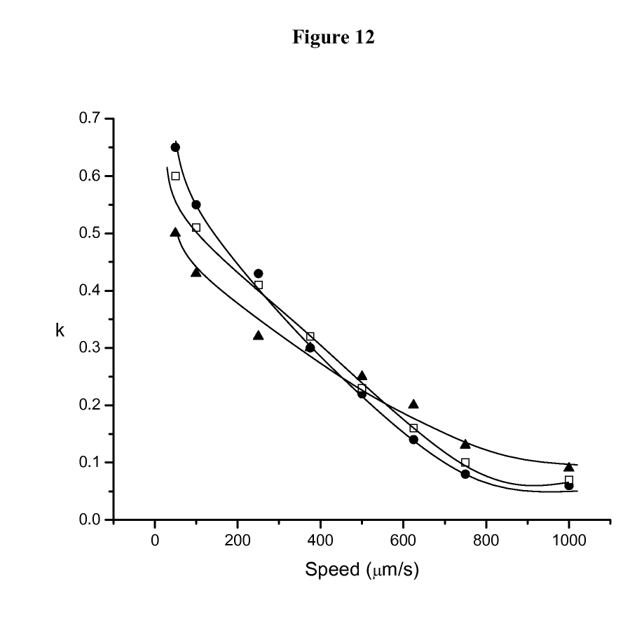

FIG. 13 is a graph showing the value of 1/(1-k)ⁿ after 15 min for 9 nm (●), 12 nm (□), and 16 nm (▴) particles.

FIG. 14 are images showing the extent of mixing for (A) 1 μm and (B) 12 nm particles after 30 min. The magnets are moving in a saw-tooth motion at a velocity of 0.25 mm/s in each direction. With 12 nm particles, the dye is uniformly spread after 30 min, but there is no significant spreading of the dye with 1 μm particles.

FIG. 15 is a graph showing 1/(1−k)ⁿ for polydisperse (●) and monodisperse (▪) particles after 15 min. The monodisperse particles have a diameter of 9 nm, whereas the polydisperse particles have a mean diameter of 9.5 nm.

FIG. 16 is a graph showing effect of concentration on k for 9 nm (●), 12 nm (□), and 16 nm (▴) particles. The magnets are moving at a velocity of 0.25 mm/s in each direction.

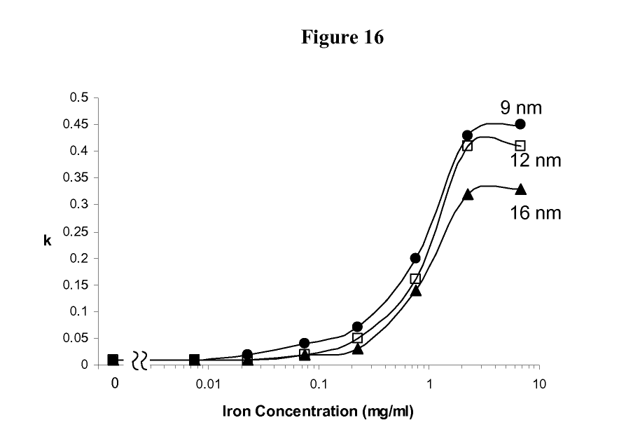

FIG. 17 is a graph showing from the area under the 2p_{1/2} peak, it could be calculated that less than 0.1% of the surface is covered with magnetic particles.

FIG. 18 are images showing hybridization with 250 pM oligo. The image on the left was without mixing, whereas the one on the right is with mixing. The ratio of the intensity is 2.92.

FIG. 19 are images showing hybridization with 1 nM oligo. The image on the left was without mixing, whereas the one on the right is with mixing. The ratio of the intensity is 2.67

FIG. 20 is a graph showing the fluorescence signal with and without mixing. The ratio of the two slopes is 2.8, which is nearly equal to the ratio of the area of the spot to the area of the chamber (3.1).

The patent or application file contains at least one drawing executed in color. Copies of this patent or patent application publication with color drawing(s) will be provided by the Patent Office upon request and payment of the necessary fee.

While the present disclosure is susceptible to various modifications and alternative forms, specific example embodiments have been shown in the Figures and are herein described in more detail. It should be understood, however, that the description of specific example embodiments is not intended to limit the disclosure to the particular forms disclosed, but on the contrary, this disclosure is to cover all modifications and equivalents as illustrated, in part, by the appended claims.

### DESCRIPTION

In general, the present disclosure provides systems employing magnetic particles, methods for mixing or moving fluids using magnetic particles, and articles of manufacture comprising magnetic particles. The systems and methods of the present disclosure may be used in applications such as, for example, health care diagnostics, drug discovery, environmental monitoring, industrial quality control, and disease detection.

The magnetic particle based mixing strategy of the present disclosure has been shown to provide enhanced mixing within microanalytical chambers. This strategy for mixing has the benefit of simplicity, and generally does not require any complicated chamber fabrication. Less sample volume is needed with this strategy. Further, the magnetic particles may be separated from a sample or solution after use, for example, in the event that the same sample or solution is to be reused.

According to one embodiment, the present disclosure provides a system comprising: a fluid chamber comprising a fluid disposed within the fluid chamber, wherein the fluid comprises a plurality of magnetic particles disposed within the fluid; and a magnetic field source disposed operative with the fluid chamber to provide a magnetic field to the fluid chamber. As used herein, the term “fluid” refers to an aggregate of matter in which the molecules are able to flow past each other without limit and without fracture planes forming (e.g., a fluid may be a liquid or a gas). Unless otherwise indicated, the term fluid does not require flow, and a fluid may be either stagnant or flowing. The systems of the present disclosure, among other things, may allow the use of smaller solution volumes with, for example, microarrays, microfluidic devices, and other related microanalytical systems.

In general, the magnetic particles provide a means for mixing a fluid in the systems of the present disclosure. Any magnetic particle suitable for the desired application may be used. The magnetic particle may be formed, at least in part, from any material affected by a magnetic field. Examples of suitable materials include, but are not limited to, magnetite, maghemite, hematite, ferrites, and materials comprising one or more of iron, cobalt, manganese, nickel, chromium, gadolinium, neodymium, dysprosium, samarium, erbium, iron carbide, iron nitride. The magnetic particles may have a size in the range of from about 1 nm to about 1 mm in diameter, and may form clusters of larger sizes. In some embodiments, the magnetic particles may have a size in the range of from about 3 to about 50 nm. In some embodiments, the magnetic particles may have a size in the range of from about 50 nm to about 1 μm. The magnetic particles may be prepared by methods including, but not limited to, chemical precipitation and ball milling. The magnetic particles may be monodisperse or polydisperse, and may be synthesized using methods known in the art such as, for example, Shen, L. F., et al. Journal of Magnetism and Magnetic Materials 194, 37-44 (1999), Ditsch, A., et al., Langmuir 21, 6006-6018 (2005), Yu, W. W., et al., Chemical Communications, 2306-2307 (2004), and Moeser, G. D., et al., Industrial & Engineering Chemistry Research 41, 4739-4749 (2002), the relevant disclosures of which are incorporated herein by reference.

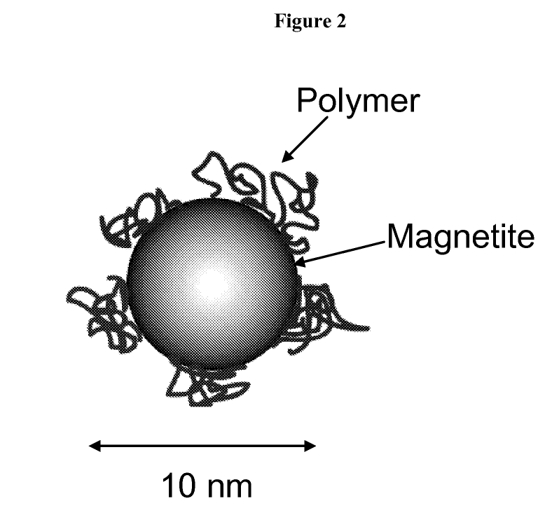

In some embodiments, the magnetic particle may be at least partially coated with a surface coating (see, for example, FIG. 2). The surface coating may be any coating suitable for use in a desired application. In some embodiments, the surface coating may inhibit the magnetic particles from settling in gravitational or moderate magnetic fields. In other embodiments, the surface coating may inhibit binding of certain molecules to the magnetic particle, or impart desired salvation properties to the magnetic particle, or both. Examples of suitable coatings include, but are not limited to, surfactants, polymers (e.g., polyethylene glycol and polyethylene glycol-containing co-polymers, copolymers of acrylic acid, styrene sulfonic acid, and vinyl sulfonic acid), decanoic acid, and other fatty acids, and biopolymer-resistant coatings described in U.S. Pat. No. 6,235,340, incorporated herein by reference. Once coated, the effective diameter of the magnetic particle may increase. For example, a magnetic particle coated with a surfactant may have an effective average size of about 45 nm, while the same magnetic particle coated with a polymer may have an effective average size of about 50 to about 100 nm, depending on the surface coating used. The particles can be coated during their synthesis, for example, during a ball milling or chemical precipitation preparation, or during a subsequent adsorption or reactive step that modifies the surface of a pre-exiting magnetic particle.

The fluid may be any fluid suitable for use with a desired application, provided the fluid does not adversely affect other components of the system. In some embodiments, the fluid should be compatible with a biomolecule. One example of a suitable fluid is water, which may or may not contain buffers, salts, surfactants, or other agents that may be required for maintaining the integrity of, for example, biological samples. In some embodiments, the system may further comprise a magnetic fluid. A magnetic fluid is a dispersion of magnetic particles in a solvent, which behave as “liquid magnets.” The solvent may be used to suspend the magnetic particles, thereby providing a means to introduce the magnetic particles to the chamber. The solvent and fluid may be the same or different. Any solvent, like water, may be used.

The fluid chamber may be any chamber suitable for use with a desired application. The chamber may have any size and be of any shape, such as, for example, a capillary, a cylinder, a planar structure, and a non-planar structure. The chamber may be adapted for a mixing or moving an initially stagnant fluid, but also may be adapted for use with flowing fluids. In certain embodiments, the fluid chamber may be present on a microfluidic device, for example, the chamber may be present on a microarray, a sensor, or a microfluidic device. In one example, the chamber is a microarray comprising a two-dimensional grid of a plurality of biomolecules such as, for example, nucleic acids, proteins, peptides, drug molecules, carbohydrates, cells, and the like, which are spotted onto a substrate, for example, a glass slide.

In some embodiments, the fluid chamber may include a sample. Generally, any sample in need of mixing or movement may be suitable. The sample may include magnetic particles and/or a fluid. For example, magnetic particles may be introduced into a sample and the sample then introduced into the fluid chamber. Samples may have any form, for example a fluid, a liquid, a dispersion, an emulsion, or have multiple phases. Examples of suitable samples include, but are not limited to, a cell culture, a biological sample (e.g., a blood preparation), an environmental sample (e.g., water sample), a food sample (e.g., for pathogen detection), a microbial sample, a forensic sample, and the like.

The magnetic field may be provided through the use of any magnet, for example, a permanent magnet or an electromagnet. One example of a suitable magnet is a neodymium block magnet. In some embodiments, the magnetic field may be manipulated so as to allow the magnetic particles to have a geometry or movement favorable for moving or mixing the fluid. The magnetic field may be continuous or pulsed in its movement, intensity, and/or location of application. Once applied, the magnetic field may be translated in any one or more directions suitable to mix or move the fluid, including regular, defined motions and chaotic motions. Examples of translation include, but are not limited to, the cycled and/or pulsed movement of a permanent magnet, or set of permanent magnets, or the alternating operations of electromagnets, or sets of electromagnets. The magnetic field may be spatially heterogeneous in order to localize magnetic fields. Localized magnetic fields may be useful, among other things, for allowing magnetic particles to form a pattern, for example, to enhance mixing.

Upon application of a sufficiently strong magnetic field, the magnetic particles align themselves along the magnetic field, and form a solid-like structure. Once formed, the magnetic field may be translated, or the fluid chamber may be translated, thereby moving the solid-like structure to create a flow within the fluid chamber. By patterning the magnetic field or modulating its application temporally, different patterns of flow could be achieved inside the chamber.

According to another embodiment, the present disclosure provides a method comprising: providing a fluid; providing a plurality of magnetic particles; providing a magnetic field; introducing the plurality of magnetic particles into the fluid to form a magnetic fluid; and

applying the magnetic field to the magnetic fluid such that the magnetic particles move within the fluid. Such methods may direct flows or provide enhanced mixing of fluids within microanalytical chambers with thin film geometries, as well as in larger chambers, for example, chambers on the millimeter or centimeter scales. Also the magnetic particles can be separated from the solution if it is desirable, for example, so the same solution can be reused.

In one example of a method for mixing a fluid according to one embodiment of the present disclosure, a magnetic fluid comprising a dispersion of magnetic particles in water is added to a solution inside a microanalytical chamber. Upon application of an external magnetic field, the magnetic particles align themselves along the magnetic field and form solid-like structures. The external magnetic field is then translated, which moves the solid-like structures. This movement may result in a flow of the solution within the chamber that leads to mixing of the solution. Also the magnetic particles can be separated from the solution after mixing if it is desirable to reuse the same solution.

According to one embodiment, the present disclosure provides an article comprising a fluid chamber; a fluid; and a plurality of magnetic particles.

### EXAMPLES

Synthesis of Magnetic Particles

One example of polydisperse magnetic particles were synthesized as described in Shen, L. F., et al. Journal of Magnetism and Magnetic Materials 194, 37-44 (1999), in which coprecipitation of Fe(II) and Fe(III) salts by NH₄OH at 80° C. produced magnetite magnetic particles. The reaction was carried out in a three-necked flask with vigorous stirring by a mechanical stirrer. 40 mL of water was deoxygenated by repeatedly sparging the water with nitrogen for 30 min. 0.86 g of FeCl₂.4H₂O and 2.35 g of FeCl₃.6H₂O was added to the water, and the solution was heated to 80° C. When the solution attained a temperature of 80° C., 100 mg of neat decanoic acid in 5 mL of acetone was added, followed by 5 mL of 28% (w/w) NH₄OH. Further decanoic acid was added to the suspension in five 0.2-g amounts spread over 5 min. After 30 min of reaction, the suspension was cooled slowly to room temperature. The suspension was precipitated with MeOH, and the magnetic particles precipitated by magnetic decantation. The cleaning and decantation procedure was repeated three times. To coat the magnetic particles with a second layer of surfactant, around 6 mL of 10% w/v solution of ammonium salt of decanoic acid was added to the precipitate, and the mixture was sonicated with a Branson sonifier for 60 seconds at 20% power output.

Experimental Setup for Visualization of Mixing

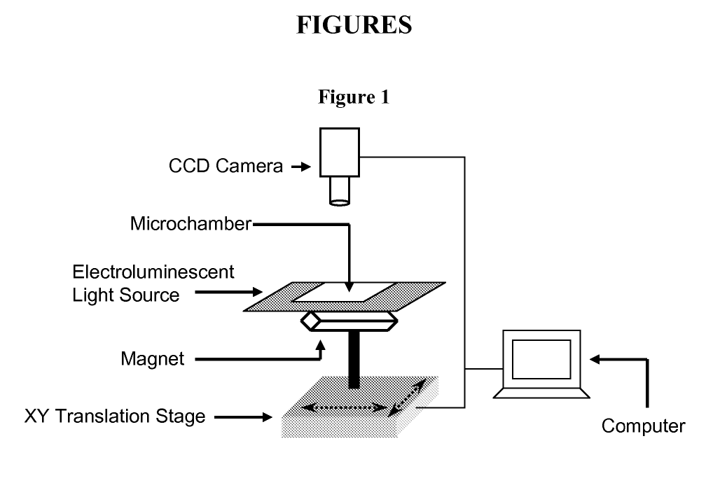

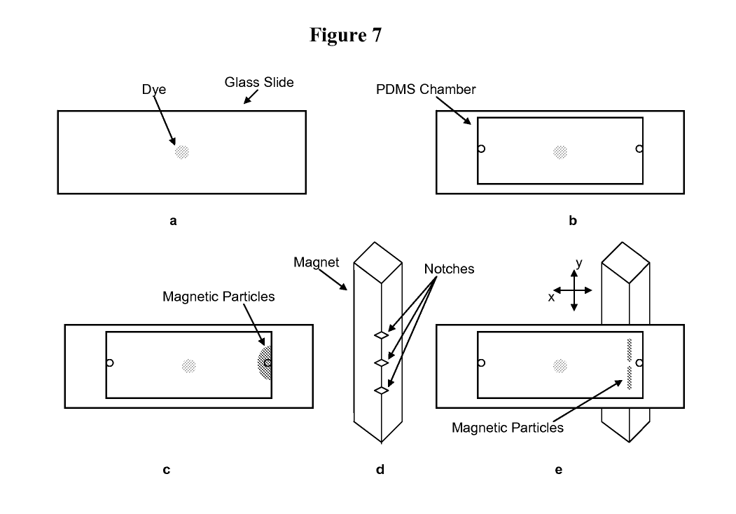

The experimental schematic is shown in FIGS. 1 and 7. The mixing process inside a water-filled chamber was visualized by erioglaucine dye. The dye was initially localized at the center of the chamber, and due to the mixing process, it spread throughout the chamber. A glass slide was spotted with 1 μL of 400 mM erioglaucine dye, and the dye was allowed to dry (FIG. 7a). The spotted dye was then covered with a layer of oligo(ethylene glycol)ₙ acrylate (n=24), so that upon exposure to water, the dye didn't dissolve instantaneously in water. A PDMS mold was prepared (using standard soft lithographic techniques) such that when placed against the glass slide, a chamber of dimensions 50 mm×20 mm×140 μm was formed, with the spotted dye at the center (FIG. 7b). The chamber was filled with 140 μL water through one of the holes in the chamber. The magnetic particles were then introduced into the chamber at one of the ends (FIG. 7c). The entire chamber was placed on top of a neodymium block magnet of dimensions 2″×0.5″×0.5″ (FIG. 7d) such that only one of the long edges of the magnet touched the chamber. The magnet had been filed at three locations to create three notches, each 2 mm wide. The magnetic particles arranged themselves in a straight line along the magnetic field, with no particles just above the notches (FIG. 7e). The magnet was translated in two directions with an XY translation stage (Zaber Technologies, Richmond, British Columbia, Canada). As the magnet was translated, the magnetic particles moved with the magnet, thus creating motion of the fluid inside the chamber. Images were taken with a Retiga 1300 CCD Camera (Qlmaging, Burnaby, British Columbia, Canada) (FIG. 1). A thin electroluminescent sheet (Being Seen Technologies Inc., Bridgewater, Mass.) between the magnet and the microfluidic chamber served as the light source for image acquisition (FIG. 1). The movement of the translation stage as well as the image acquisition was controlled using code written in Labview. In some instances, the magnet was moved in a saw tooth motion with amplitude of 1 mm and period of 4 mm. The magnet moved 45 mm along the length of the chamber, after which it reversed its direction and returned back to its original position. The motion of the magnet from one end to another is designated as one pass.

Calculating Standard Deviation

After the images were acquired, they were analyzed using a code written in Labview to quantify the extent of mixing. Each pixel was corrected for temporal and spatial variation of the light source. For image analysis, a central area of 43.5 mm×18 mm was selected to quantify the extent of mixing. The intensity of individual pixels in the selected area was converted to concentration of dye based on a calibration curve. The mean and the standard deviation of the concentration was calculated, and the ratio of standard deviation over mean of concentration is reported as γ. The standard deviation would be highest initially, when the dye in unmixed; as the liquid inside the chamber is mixed, the value of γ will decrease with time, until it eventually reaches the background noise.

Data Analysis (Equation Relating Standard Deviation and k)

The mixing process can be thought of as a first-order reaction. We can then define rate of mixing per pass, k, which is analogous to the rate of reaction. For a particular mixing experiment, k can be related to γ values through the following derivation.

Consider a chamber which has P pixels. A fraction A of the pixels (i.e. AP pixels) are mixed, or black, whereas P(1−A) pixels are unmixed or white. Also, let each mixed pixel has a concentration of 1, whereas unmixed pixels have a concentration of 0.

The mean concentration is

$$M = \frac{AP}{P} = A .$$

Let a fraction, k, of the white be mixed, or become black, after each pass. Then number of white pixels remaining after first pass is P[1−A−(1−A)ₖ]=P(1−A)(1−k). The number of white pixels after two passes is: P(1−A)(1−k)², and so on so forth. After n passes, the number of white pixels is: P(1−A)(1−k)ⁿ, and the number of black pixels is: P[1−(1−A)(1−k)ⁿ]. Assuming all the black pixels are equally black, the concentration of each black pixel is

$$\frac{A}{1 - ( 1 - A ) {( 1 - k )}^{n}}$$

$$\begin{matrix}P ( 1 - A ) {( 1 - k )}^{n} {( 0 - A )}^{2} + P [ 1 - ( 1 - A ) {( 1 - k )}^{n} ] \\ {( \frac{A}{1 - ( 1 - A ) {( 1 - k )}^{n}} - A )}^{2}\end{matrix}$$

such that the mean remains A.

The standard deviation is:

$${Y}_{n} = \sqrt{\frac{\begin{matrix}P ( 1 - A ) {( 1 - k )}^{n} {( 0 - A )}^{2} + P [ 1 - ( 1 - A ) {( 1 - k )}^{n} ] \\ {( \frac{A}{1 - ( 1 - A ) {( 1 - k )}^{n}} - A )}^{2}\end{matrix}}{P}}$$

$${Y}_{n} = \sqrt{( 1 - A ) {( 1 - k )}^{n} {A}^{2} + [ 1 - ( 1 - A ) {( 1 - k )}^{n} ] \\ {( \frac{A}{1 - ( 1 - A ) {( 1 - k )}^{n}} - A )}^{2}}$$

$${Y}_{n} = \sqrt{( 1 - A ) {( 1 - k )}^{n} {A}^{2} + \frac{{{A}^{2} ( 1 - A )}^{2} {( 1 - k )}^{2 n}}{1 - ( 1 - A ) {( 1 - k )}^{n}}}$$

$${Y}_{n} = \sqrt{\frac{{{A}^{2} ( 1 - A )}^{2} {( 1 - k )}^{n}}{1 - ( 1 - A ) {( 1 - k )}^{n}}}$$

$${Y}_{n} = A \sqrt{\frac{{( 1 - A )}^{2} {( 1 - k )}^{n}}{1 - ( 1 - A ) {( 1 - k )}^{n}}}$$

$$Defining {γ}_{n} as the ratio of standard deviation over mean , \\ {γ}_{n} = \frac{{Y}_{n}}{A} = \sqrt{\frac{{( 1 - A )}^{2} {( 1 - k )}^{n}}{1 - ( 1 - A ) {( 1 - k )}^{n}}}$$

$${γ}_{n} = \sqrt{\frac{{( 1 - k )}^{n}}{1 / c - {( 1 - k )}^{n}}}$$

where c=1−A is the initial white fraction.

To determine the value of k and c, the above equation is fitted in Origin software. The value of c is dependent on the initial area covered by the dye, and is typically 0.98 (with γ₀=7).

Another parameter considered was the rate of mixing with time, rather than number of passes. This is may be pertinent if to compare the extent of mixing at different velocities, as different velocities would imply different number of passes in the same amount of time. Therefore, we have defined another parameter, the actual rate of mixing as 1/(1−k)ⁿ.

Results

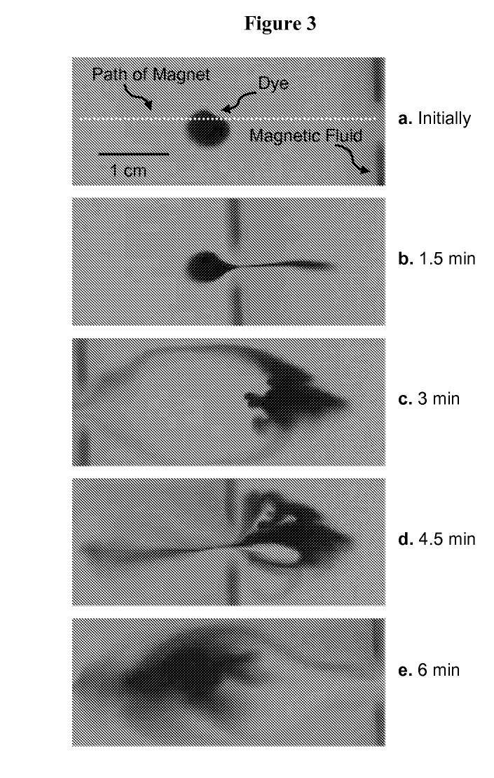

Referring to the experimental schematic shown in FIG. 1, the neodymium block magnet of dimension 2″×0.5″×0.5″ was rotated at an angle of 45°, such that the long edge of the magnet touched the bottom surface of the chamber. For our initial experiments, the long edge of the magnet was lined along the width of the chamber and the magnet had a notch at the center, which was made by filing the magnet. Consequently, the magnetic magnetic particles arranged themselves along a straight line, with a gap in the middle. FIG. 3 shows images recorded at various time intervals for the movement of magnet. The magnet moved linearly for a distance of 45 mm at a speed of 0.25 mm/s, taking 3 min to reach from one end to another. Upon reaching one end, the magnet traversed back to the original location, and the magnet moved in this oscillatory fashion for mixing the fluid. As the magnet moved, the solution inside the chamber flowed through the gap in the magnetic fluid, thus leading to mixing. We also performed experiments with no crevice in the magnet. But due to non-uniformity of the magnet surface, there were regions where the magnetic field was weakest, and the solution flowed through those regions.

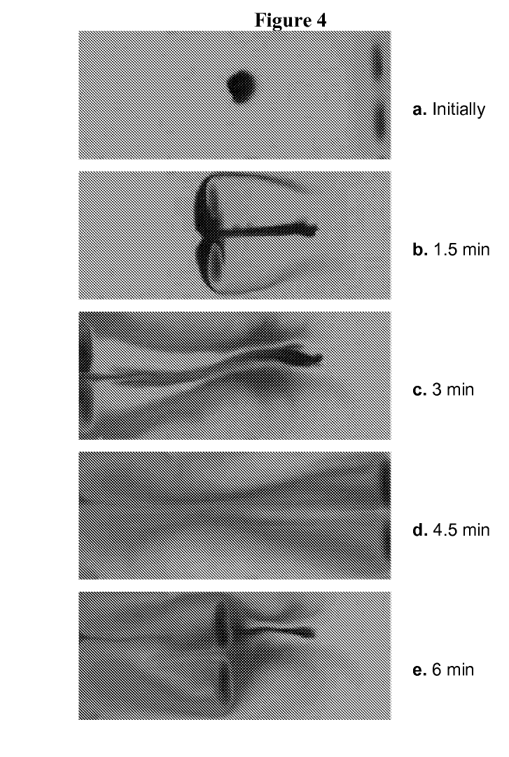

The drawback of one notch in the magnet is that the solution along the side walls of the chamber is not mixed. To obtain better levels of mixing, the magnet was notched at multiple locations so that the solution moved not only along the middle of the chamber, but also along the sides. In FIG. 4, the images for the movement of the magnet with three crevices are shown. The mixing in this case is more efficient as compared to the previous one when there was just one crevice in the magnet. The speed and direction of the magnet were the same as in previous case

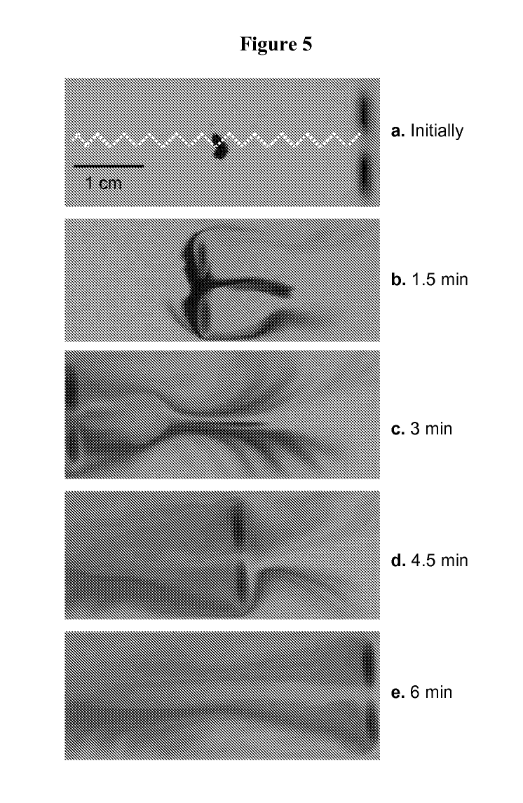

To further enhance the mixing along the width of the chamber, the magnet was moved in a saw tooth pattern, translating along both the length and the width of the channel. The images for such a movement of the magnet with three crevices are shown in FIG. 5. In FIG. 5c, streaks of dye emanating from the center of the chamber to the sidewalls can be observed, which were not present for the linear motion of the magnet. The separation between two such streaks is the same as the distance between the peaks of consecutive saw teeth of the path of the magnet.

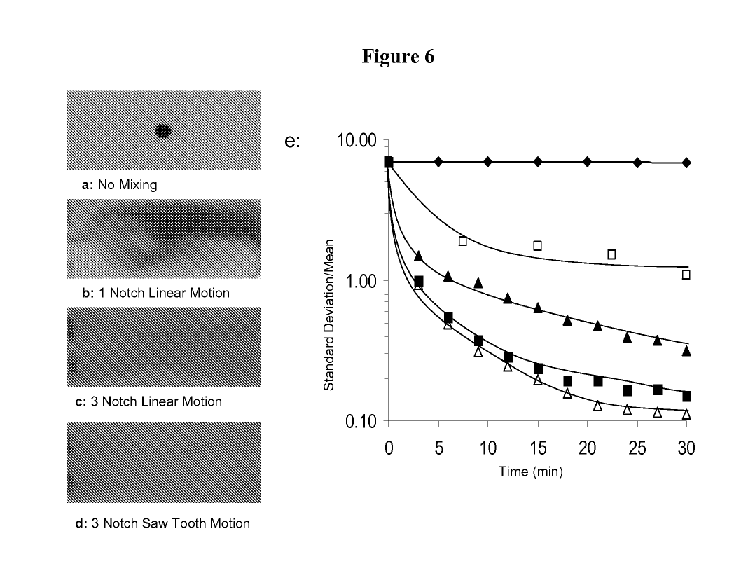

FIG. 6a to 6d shows snapshots at the end of 15 minutes for different arrangements and motions of the magnet. For the case where no mixing was provided, the spreading of the dye depended only on diffusion. When there was one crevice in the magnet, and the motion of magnet was linear, mixing primarily occurred along the center of the chamber, but no substantial movement of the solution happened along the width of the chamber. Saw tooth motion of the magnet with three crevices provided the most efficient mixing of the solution. To confirm these observations, we converted the pixel intensities to local concentration of dye, and plotted the ratio of standard deviation over mean of concentration against time in FIG. 6e. The region containing the magnetic fluid was excluded for the purpose of quantification. The standard deviation for the case of three holes saw tooth motion dropped to the background level in around 15 minutes. The speed of the magnet also was varied, and it was found that the optimal speed of the magnet in this configuration was 0.25 mm/s. At lower speeds of the magnet, for example at 0.1 mm/s (represented by □ in FIG. 5e for the case of one crevice in the magnet), the mixing achieved was less efficient, whereas for higher speeds of the magnet, a significant trailing of the magnetic particles was observed.

As the magnetic particles move along the chamber, they will impart a certain velocity to the surrounding fluid. The motion of the particles as well as the fluid creates a pressure drop across the particle bed, due to which the fluid is ejected out of the notches, leading to mixing. A rough idea of the pressure drop can be derived if we assume that the bed of magnetic particles is like a fluidized bed. In that case, the Kozeny-Carman equation can be applied to calculate the pressure drop:

$$\frac{Δ P}{w} = \frac{150 v {μ ( 1 - ɛ )}^{2}}{{ϕ}_{s}^{2} {d}_{p}^{2} {ɛ}^{3}}$$

The Kozeny-Carman equation is usually applied to particles in the micron and millimeter range. It has also been applied to nanoparticles sieves as well, and has been found to be roughly valid. Kozeny-Carman equation is derived assuming that the porous spaces in the bed form uniform capillaries whose walls are defined by the particles (For elements of this derivation, see Mccabe, W. L., Smith, J. C. & Harriott, P. Unit Operations of Chemical Engineering (McGraw-Hill, New York, 2001)). As such, large deviations occur for experimental and calculated values of pressure drop at high porosities.

If Stokes law is valid, then the pressure drop relationship can simply be derived by adding the pressure drop due to each particle. For a single sphere, the Stoke's law is
F_{d}=3πμdₚν
Adding pressure drop due to individual particles, we get the relation,

$$\frac{Δ P}{w} = \frac{18 ( 1 - ɛ ) μ}{{d}_{p}^{2}} v$$

$$where = {( 1 - ɛ )}^{\frac{1}{3}}$$

A more rigorous equation can be derived by assuming that each particle has a spherical cover of fluid, and the individual covers do not interact with each other. The equation in that case is

$$\frac{Δ P}{w} = [ ( \frac{3 + 2 {δ}^{5}}{3 - \frac{9}{2} δ + \frac{9}{2} {δ}^{5} - 3 {δ}^{6}} ) ( \frac{18 {δ}^{3} μ}{{d}_{p}^{2}} ) v ]$$

$$where δ = {( 1 - ɛ )}^{\frac{1}{3}}$$

All the above derivations suggest that the pressure drop is inversely proportional to the second power of the diameter of particles, provided the porosity remains constant. Therefore, as the particle diameter increases, the pressure drop across the magnetic particle bed would be lower; consequently the mixing would be less efficient.

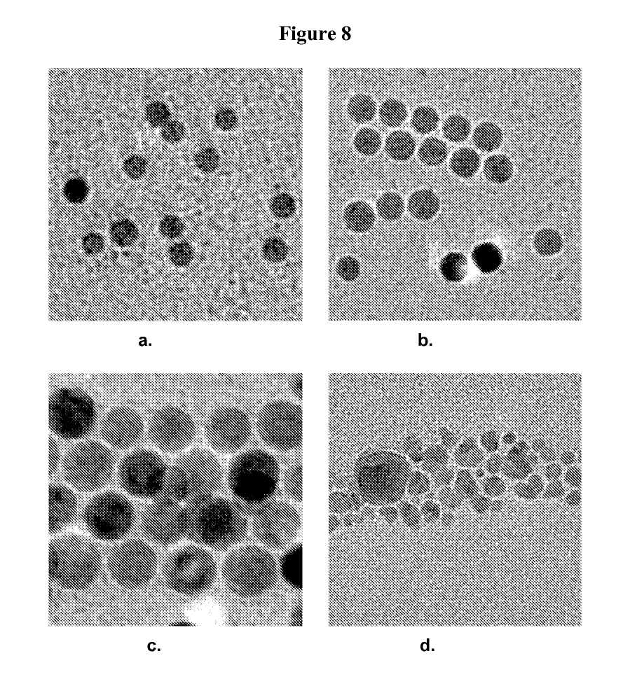

Size dependence of different monodisperse particles on mixing was investigated with three different sizes: 9 nm, 12 nm, and 16 nm particles. The TEM images of each of the particles is shown in FIG. 8, and the particles are monodisperse within ±5%.

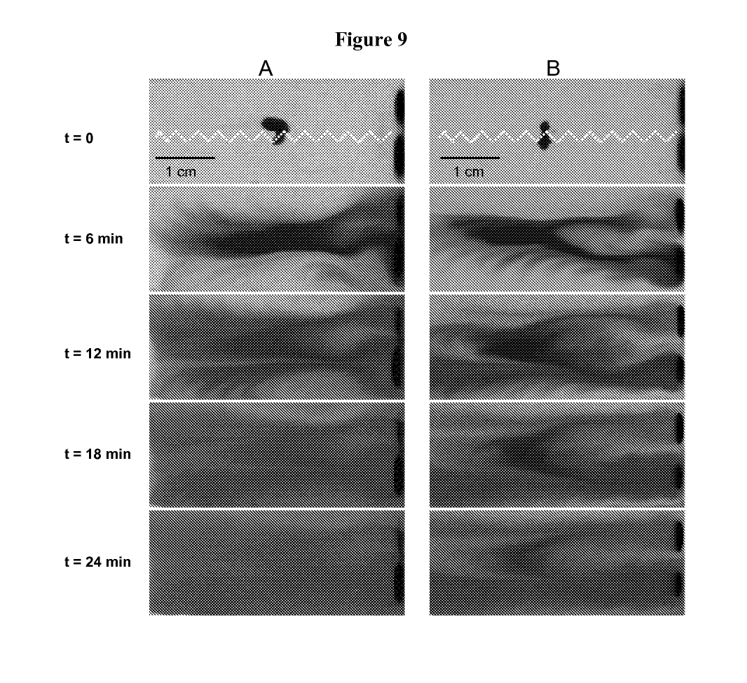

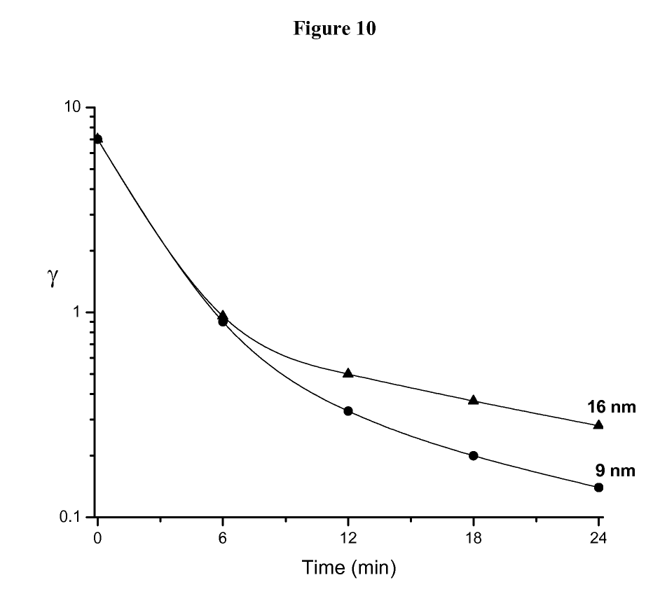

FIG. 9 shows the mixing for 9 nm and 16 nm particles. It is evident that the 9 nm particles lead to better mixing than 16 nm particles. The magnet moved at a speed of saw tooth motion with a velocity of 0.25 mm/s in each direction. FIG. 10 shows the decrease of with time for 9 nm and 16 nm particles.

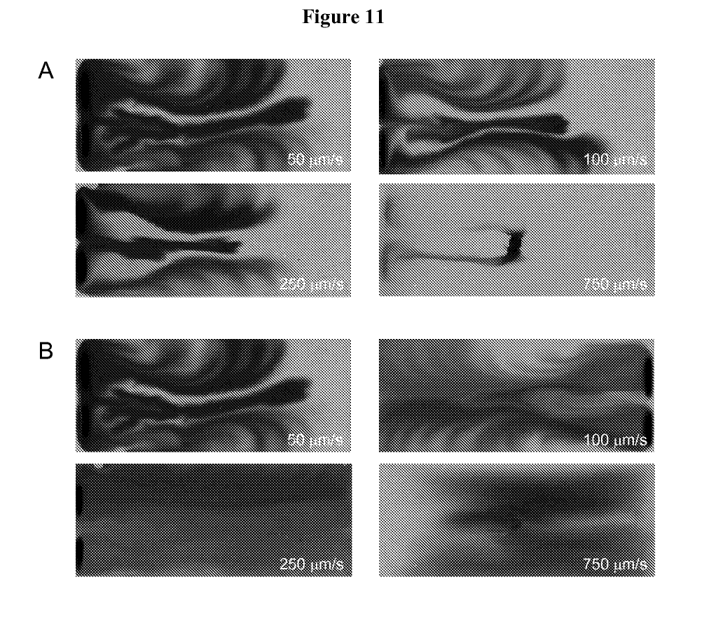

In FIG. 1A, the images at the end of first pass are shown for different velocities for 12 nm particles. The mixing per pass is better for a slower velocity than a higher velocity. At a particularly high velocity (for example at 750 μm/s in FIG. 11A), the particles trail significantly leading to low mixing per pass.

Even though lower velocity implies higher mixing per pass, the number of passes would be lesser for a lower velocity. In FIG. 11B, the images of mixing has been shown after 15 min for 12 nm particles at the same velocities considered above. The extent of mixing is greater as the velocity of the magnet is increased until a certain velocity is reached, after which increased trailing decreases the extent of mixing.

To quantify the extent of mixing, the mixing parameter k has been plotted in FIG. 6 for different particles. A clearer picture is obtained when rate of mixing, 1/(1−k)ⁿ is plotted for different magnetic particles (FIG. 7). At lower speeds, the mixing is best for smaller magnetic particles. At a velocity of around 250 μm/s, the 9 nm particles start trailing significantly, due to which the value of mixing parameter decreases. For 12 nm, the trailing starts above 375 μms, whereas for 16 nm, the trailing starts above 500 μm/s. From the above experiments it is clear that as long as the magnetic particles don't trail, the mixing deteriorates as we increase the particle size.

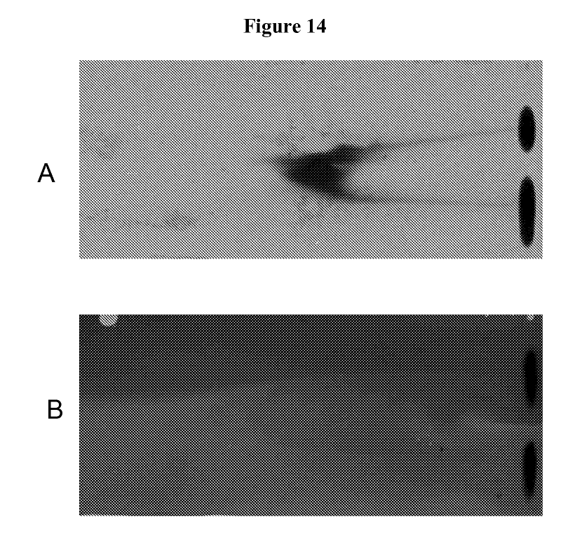

If micron-sized particles are used rather than magnetic particles, then we can expect the extent of mixing to decrease considerably. In FIG. 14, we have plotted the results for 1 μm particles. The experiments were run at 0.25 mm/s, since none of the magnetic particles trailed at that velocity. For 1 μm particles there is negligible mixing, whereas the fluid is completely mixed for 12 nm particles

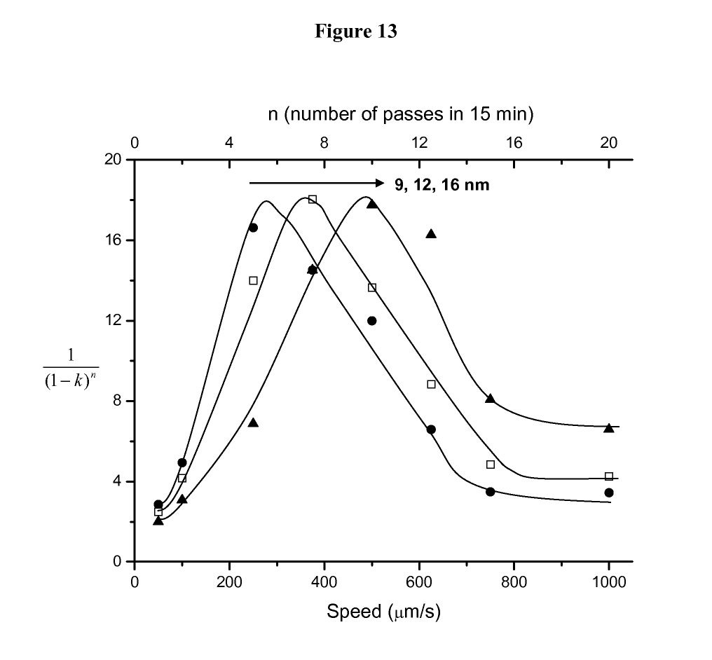

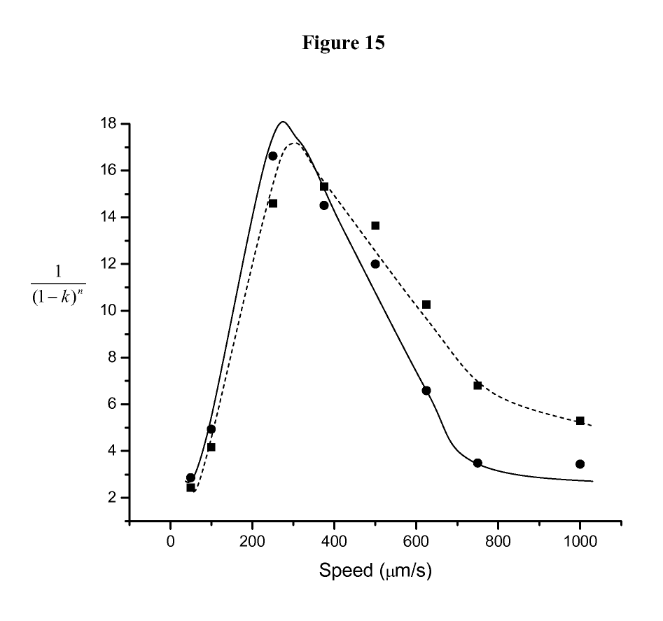

Monodisperse particles, though ideal for analyses, are difficult to synthesize. In practical applications, it may be more efficient to use polydisperse magnetic particles for mixing. In FIG. 15, we have plotted the value of rate of mixing at different velocities for polydisperse particles (mean diameter of 9.5 nm) and monodisperse particles of 9 nm. It can be seen that the mixing of the polydisperse particles is nearly the same as that for the 9 nm monodisperse particles, except at higher velocities, when the polydisperse particles show better mixing. This can be explained by the fact that the polydisperse particles would have some larger magnetic particles, which have better mixing at higher velocities, as can be seen for 16 nm particles in FIG. 13.

Interaction of Magnetic Particles with Different Surfaces

The Damkohler number is a good measure of the effectiveness of mixing in such chambers as it indicates whether a chemical process is diffusion-limited or reaction-limited. It is given by Da=k_{f}Γ₀R/D, and is the ratio of the maximum rate of surface reaction (=k_{f}Γ₀C₀) to the maximum rate of diffusion (=D(C₀/R)), where k_{f} is the forward rate constant for DNA binding, Γ₀ is the initial surface density of the spotted probes on the surface, C₀ is the initial concentration of complementary solution phase species, R is the thickness of the chamber, and D is the diffusion constant of the solution phase species. A high value of Da (>10) indicates that the reaction is diffusion-limited, whereas a low value of Da (<0.1) indicates that the reaction is much slower than the diffusion. Consider a DNA microarray experiment without any mixing. Assuming R=25 μm, k_{f}=10⁶M⁻¹ s⁻¹, D=2.5×10⁻¹¹ m²/s, and Γₒ=10⁻⁸ moles/m², Da is estimated to be 10,000, which indicates that without any mixing the hybridization process is diffusion-limited. Now consider the case when mixing is provided. Let t (=15 minutes) be the time required for complete mixing of the chamber. During this time, the area of solution from where the DNA molecules are available for hybridization is given by LW, where L is the length and W is the width of the chamber. Without mixing, the area of solution from where the freely moving DNA molecules are available for hybridization in time t is given by Dt. Therefore we can substitute D with LW/t in the equation for Damkohler number, thus giving a Damkohler number of 0.1, which indicates that with mixing, the DNA hybridization process is now reaction limited. The above analyses indicate that not only the hybridization process with mixing should take much less time than the prevalent practice of 16-24 hours, but also the final signal should be more quantitative and reproducible.

Mixing experiments were conducted with magnetic particles to investigate improved hybridization. Briefly, a glass slide was cleaned by immersing in piranha solution (70:30H₂SO₄/30% H₂O₂) for 30 minutes. The slides were rinsed with water and dried under a stream of nitrogen gas. The glass slides were then immersed in a 0.5 vol % solution of N-(propyl-3-triethoxysilane)-4-hydroxy-butyramide (HBPTES) in ethanol-water (95:5) for 16 hours to generate a hydroxyl-terminated monolayer on the glass surface. DNA sequences were synthesized on the hydroxyl monolayers using a DNA synthesizer (ABI 3200 from Applied Biosystems) and nucleotide phosphoramidite reagents (Glen Research) using procedures similar to those described in U.S. Patent Application Publication Number 20020028455. The synthesis of the oligonucleotide was performed on an inner region of the glass surface, roughly 2 cm in diameter, as defined by the region of contact between the glass surface and the fluidic flow for the modified DNA synthesizer system.

Using the above solid-phase reactions, a DNA strand on the glass slides was produced with the base sequence 5′AGC ATG GCG CCT TT 3′ where the 3′ end was attached to the HPBTES monolayer on the glass surface. The slide was covered with a piece of a polydimethylsiloxane (PDMS) that was constructed to generate a chamber of dimensions 50 mm×20 mm×0.14 mm between the slide and the PDMS cover. Into this chamber, 0.14 mL of hybridization solution was pipetted. The hybridization solution consisted of the target DNA strand (specifically, 3′AGG CGC CAT GCT 5′) in 3×SSC (saline sodium citrate), 0.2 wt-% SDS (sodium dodecyl sulfate) buffer in water. The target strand was complementary to the last twelve bases of the probe strands synthesized on the glass surface, and contained Cy3 dye at its 3′ end. The target was custom synthesized by Integrated DNA Technologies (Coralville, Iowa) and used with the above buffer solutions with target oligonucleotide concentrations from 100 to 1000 pm. To compare the effects of mixing by the magnetic fluids on DNA hybridization, experiments were conducted using these target oligonucleotide solutions in the absence or presence of the magnetic particles. In these latter experiments, 5 μL of magnetic fluid (consisting of 8 wt % magnetite) was added. A magnet with one notch was moved in a saw-tooth fashion (amplitude=3.85 mm; period=15.4 mm) at a speed of 0.167 mm/s. For all samples, the hybridization reaction was allowed to proceed for 1 h in the presence of a translating magnetic field after which the PDMS cover was removed and the slides were washed in 3×SSC for 1 min. The slides were then dried in a nitrogen gas stream and the fluorescent signals were obtained by scanning in GenePix Scanner (Axon Instruments).

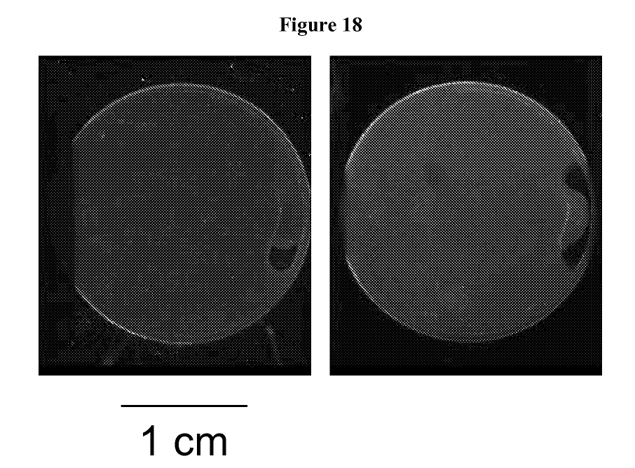

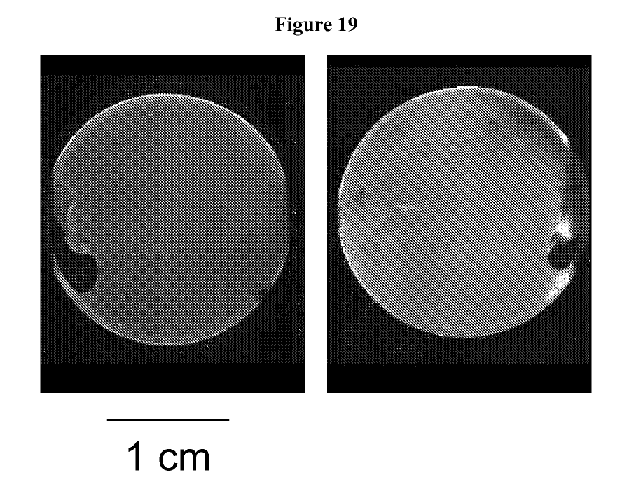

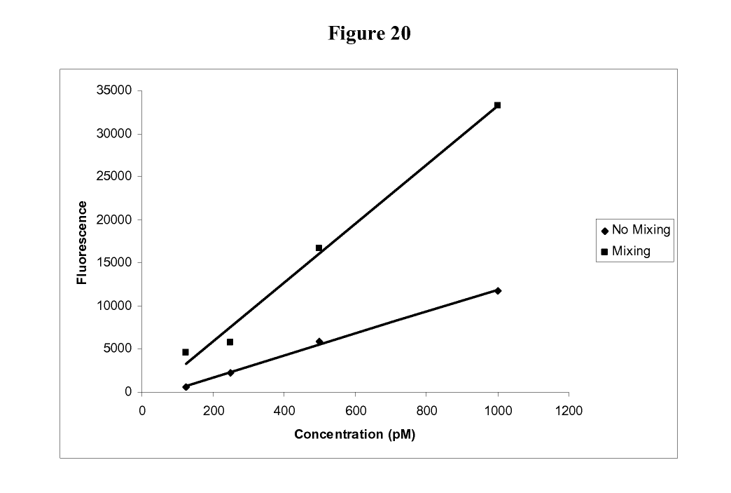

Magnetic particle adsorption on the DNA surface was measured by quantization of UV-Vis signal at 320 nm, with results shown in Table 1. FIG. 18 shows hybridization with 250 pM target oligo. The image on the left was without mixing, whereas the one on the center is with mixing. The ratio of the intensity is 2.92. The rightmost image is for non-complementary strand (without any mixing). FIG. 19 shows hybridization with 1 nM oligo. The image on the left was without mixing, whereas the one on the right is with mixing. The ratio of the intensity is 2.67. Comparisons of fluorescence signals between samples containing and excluding the magnetic particles provided illustration of the influences of mixing on hybridization. The results from these comparisons are shown in FIG. 20.

TABLE 1

| | Absorbance |
|---|---|
| Plain glass slide | ±0.002 |
| Slides with OH SAMS | ±0.004 |
| DNA Surface | 0.005 ± 0.001 |
| DNA surface after mixing with | 0.006 ± 0.002 |
| magnetic fluid for four hours | |

Area of DNA covered with magnetic particles is less than 0.1% of a complete monolayer of magnetic particles.

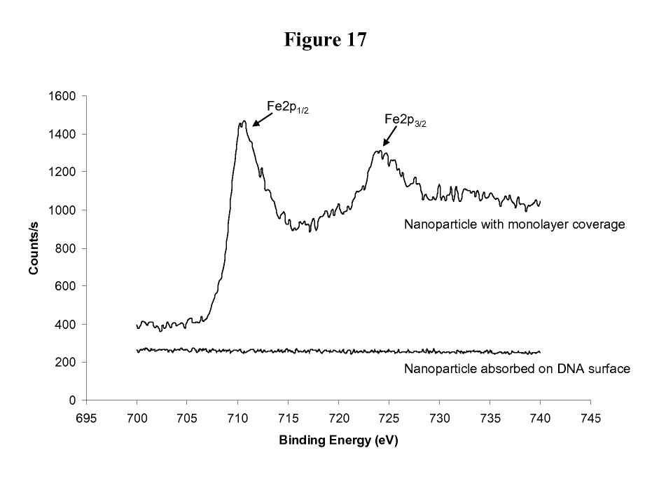

X-ray Photo Electron Spectroscopy (XPS) signals were taken for slides after mixing and subsequent washing to determine particle adsorption in experiments conducted using magnetite particles. The results are shown in FIG. 17. XPS was performed for one hour with a Pass Energy of 26 eV and resolution of 0.2 eV, and signal were fitted with Multipak software. The parameters for fitting are Gaussian=70%, FWHM=3.5. The amount of Fe present was calibrated with dried magnetic particle on an Indium foil, assuming that the signal from dried magnetic particles is the maximum signal achievable from monolayer coverage of magnetic particles. From the area under the 2p_{1/2} peak, it could be calculated that less than 0.1% of the DNA surface is covered with nanoparticles.

Therefore, the present invention is well adapted to attain the ends and advantages mentioned as well as those that are inherent therein. While numerous changes may be made by those skilled in the art, such changes are encompassed within the spirit of this invention as defined by the appended claims.

What is claimed is:

1. A system comprising:
a fluid chamber comprising a fluid disposed within the fluid chamber, wherein the fluid comprises a plurality of magnetic particles disposed within the fluid; and
a magnetic field source disposed operative with the fluid chamber to provide a magnetic field to the fluid chamber.

2. The system of claim 1 wherein the fluid is a liquid.

3. The system of claim 1 further comprising a magnetic fluid disposed within the fluid chamber, wherein the magnetic fluid comprises a solvent and a plurality of magnetic particles.

4. The system of claim 1 wherein the plurality of magnetic particles are formed from a material affected by a magnetic field.

5. The system of claim 1 wherein the magnetic particles comprise at least one material chosen from magnetite, maghemite, hematite, ferrite, iron, cobalt, manganese, nickel, chromium, gadolinium, neodymium, dysprosium, samarium, erbium, iron carbide, and iron nitride.

6. The system of claim 1 wherein the plurality of magnetic particles have a size in the range of from about 1 nm to about 1 mm in diameter.

7. The system of claim 1 wherein the plurality of magnetic particles have a size in the range of from about 3 nm to about 50 nm.

8. The system of claim 1 wherein the plurality of magnetic particles are at least partially coated with a surface coating.

9. The system of claim 1 wherein the plurality of magnetic particles comprise at least one surface coating chosen from a surfactant, a polymer, a polyethylene glycol, a polyethylene glycol-containing co-polymer, a copolymer of acrylic acid, styrene sulfonic acid, and vinyl sulfonic acid, decanoic acid, a fatty acid, and a biopolymer-resistant coating.

10. The system of claim 1 wherein the fluid chamber has the shape of a capillary, a cylinder, a planar structure, or a non-planar structure.

11. The system of claim 1 wherein the fluid chamber is present on a microfluidic device.

12. The system of claim 1 wherein the magnetic field source is provided by at least one magnet chosen from a permanent magnet and an electromagnet.

13. The system of claim 1 wherein the fluid may contain at least one magnetically responsive phase.

14. The system of claim 1 wherein the magnetic field source provides a magnetic field that is spatially heterogeneous.

15. A method for mixing comprising providing a plurality of magnetic particles disposed within a fluid and applying a magnetic field to the magnetic particles such that the magnetic particles move within the fluid.

16. The method of claim 15 wherein the magnetic particles are further disposed within a fluid chamber.

17. The method of claim 15 wherein the magnetic particles are further disposed within a fluid chamber, and the fluid chamber is present on a microfluidic device.

18. The method of claim 15 wherein applying the magnetic field comprises permitting the magnetic field to change over time to move the plurality of magnetic particles within the fluid so as to move the fluid.

19. The method of claim 15 wherein the magnetic field source is provided by at least one magnet chosen from a permanent magnet and an electromagnet.

20. The method of claim 15 wherein the fluid chamber is spatially changed to move the plurality of magnetic particles within the fluid.

21. The method of claim 15 further comprising introducing the magnetic particles into a fluid chamber.

22. The method of claim 15 further comprising introducing the magnetic particles into a fluid chamber, the fluid chamber further comprising a sample.

23. The method of claim 15 further comprising introducing the fluid into a sample.

24. An article comprising:
a fluid chamber that comprises a fluid disposed within the fluid chamber, wherein the fluid comprises a plurality of magnetic particles disposed within the fluid.

25. The article of claim 24 wherein the fluid chamber has the shape of a capillary, a cylinder, a planar structure, or a non-planar structure.

26. The article of claim 24 wherein the chamber is a substantially closed chamber.

27. The article of claim 24 wherein the fluid chamber is present on a microfluidic device.

28. The article of claim 24 wherein the plurality of magnetic particles are formed from a material affected by a magnetic field.

29. The article of claim 24 wherein the magnetic particles comprise at least one material chosen from chosen from magnetite, maghemite, hematite, ferrite, iron, cobalt, manganese, nickel, chromium, gadolinium, neodymium, dysprosium, samarium, erbium, iron carbide, and iron nitride.

30. The article of claim 24 wherein the plurality of magnetic particles have a size in the range of from about 1 nm to about 1 mm in diameter.

31. The article of claim 24 wherein the plurality of magnetic particles have a size in the range of from about 3 nm to about 50 nm.

32. The article of claim 24 wherein the plurality of magnetic particles are at least partially coated with a surface coating.

33. The article of claim 24 wherein the plurality of magnetic particles comprise at least one surface coating chosen from a surfactant, a polymer, a polyethylene glycol, a polyethylene glycol-containing co-polymer, a copolymer of acrylic acid, styrene sulfonic acid, and vinyl sulfonic acid, decanoic acid, a fatty acid, and a biopolymer-resistant coating.

34. The article of claim 24 wherein the chamber comprises a plurality of biomolecules.

35. The article of claim 24 wherein the chamber comprises a plurality of biomolecules, the biomolecules chosen from one or more of nucleic acids, proteins, peptides, drug molecules, carbohydrates, and cells.
